(19) United States
(12) Patent Application Publication
(10) Pub. No.: US 2006/0218572 A1
(43) Pub. Date: Sep. 28, 2006

(54) Audience response systems, methods and apparatus

(76) Inventors: Scott Thielman, Seattle, WA (US); George Niederauer, Seattle, WA (US)

Correspondence Address: DWC LAW FIRM, P.S., P.O. Box 3041, Seattle, WA, 98114-3041, US

(21) Appl. No.: 11/372,995

(22) Filed: Mar. 9, 2006

Related U.S. Application Data
(60) Provisional application No. 60/661,052, filed on Mar. 9, 2005.

(51) Int. Cl. H04H 9/00; H04N 7/16

(52) U.S. Cl. 725/13

(57) ABSTRACT

In some embodiments of the present invention, a wireless audience response system can have a host unit, presenter device, and a plurality of audience response units with keypads, with the host unit being communicatively coupled to a computer. The audience response units can check-in to the host unit based on adjustable check-in times that are updated and adjusted by the host unit and transmitted to the audience response units.

### CROSS-REFERENCE TO RELATED APPLICATION(S)

This application claims the benefit of U.S. provisional patent application Ser. No. 60/661,052, filed Mar. 9, 2005, which is incorporated herein by reference in its entirety.

### BACKGROUND OF THE INVENTION

1. Field of the Invention

The present invention relates to audience response systems for use in wireless audience participation.

2. Description of Related Art

Audience response systems or audience participation systems typically include a host unit or base unit connected to a computer or other processing device, and a plurality of remote devices or audience response units with keypads. The audience response units can be used by audience members to input information or commands for transmission to the host unit via a wired or wireless communication link.

Wireless audience response systems, including infrared and radio frequency (RF) systems, have advantages over hard-wired systems, such as portability and flexibility. Also, the reliability and available features of wireless audience response systems continue to improve and grow, lending to a wider array of applications and increased rate of implementation. The wide array of applications include those in education (in class room environments at all levels of education) and various types of business and seminar or presentation environments. In these environments, audience members can respond to inquiries or transmit other types of information at their selection, using an audience response keypad, while simultaneously interacting both visually and verbally in the physical audience environment. The transmitted responses (or other types of information) can be immediately analyzed via a computer or other processing device. The analysis can comprise displaying graphical tables, graphs or charts on a computer monitor or other display device. Also, audience response systems are often used to administrate or deliver tests, quizzes and surveys, etc, or to play educational games, wherein responses to inquiries can be immediately graded, checked or analyzed. Although a comprehensive discussion of all applications cannot be provided here, the applications are wide ranging and indeed, they continue to grow. In part because of the wide-ranging applicability of these systems, there is a need to continue to improve features and reliability to fulfill needs in different environments.

### BRIEF SUMMARY OF THE INVENTION

In some embodiments of the present invention, a wireless audience response system is provided having a plurality of audience response units, at least one host unit and at least one RF transceiver module provided within each of the host unit and audience response units.

The audience response system can provide networked communications between the audience response units and the host unit. In some embodiments, the audience response units receive check-in period commands from the host unit. The check-in period commands adjust the rate at which audience response units attempt to check-in to send or receive data from the host unit. The check-in period can be adjusted as a function of one or more variables, including, without limitation, (a) number of audience response units logged into the network, (b) most recent measured check-in frequency of audience response units, and (c) anticipated activity.

### BRIEF DESCRIPTION OF SEVERAL VIEWS OF THE DRAWINGS

FIG. 1 is a diagram showing components of an embodiment of the audience response system of the present invention.

FIG. 2a is an overhead plan view of an audience response unit (portable unit) for use with some embodiments of the present invention.

FIG. 2b is an overhead plan view of an alternative embodiment of an audience response unit for the present invention.

FIG. 3 is a simplified block diagram of certain components of the audience response units of FIGS. 2a & 2b.

FIG. 4 is a time chart showing events in a beacon period.

FIG. 5 is a flow chart showing an embodiment of the present invention involving the adjustment of check-in period based on measured check-in frequency.

FIG. 6 is an event diagram depicting an embodiment of the present invention wherein a plurality of different events can impact check-in period.

### DETAILED DESCRIPTION OF THE INVENTION

In the following description, certain specific details are set forth in order to provide a thorough understanding of various embodiments of the invention. However, upon reviewing this disclosure one skilled in the art will understand that the invention may be practiced without many of these details. In other instances, well-known or widely available structures, hardware, software and wireless protocol and standards associated with implementation of network layers, from physical to medium access control, and network applications, application program interfaces and application programs have not been described in detail to avoid unnecessarily obscuring the descriptions of the embodiments of the invention.

The discussion below discloses, among other things, using the present invention in the area of wireless audience participation using lower power wireless networking in a primarily star configuration. However, as will be understood by one skilled in the art after reviewing this disclosure, various other configurations are contemplated.

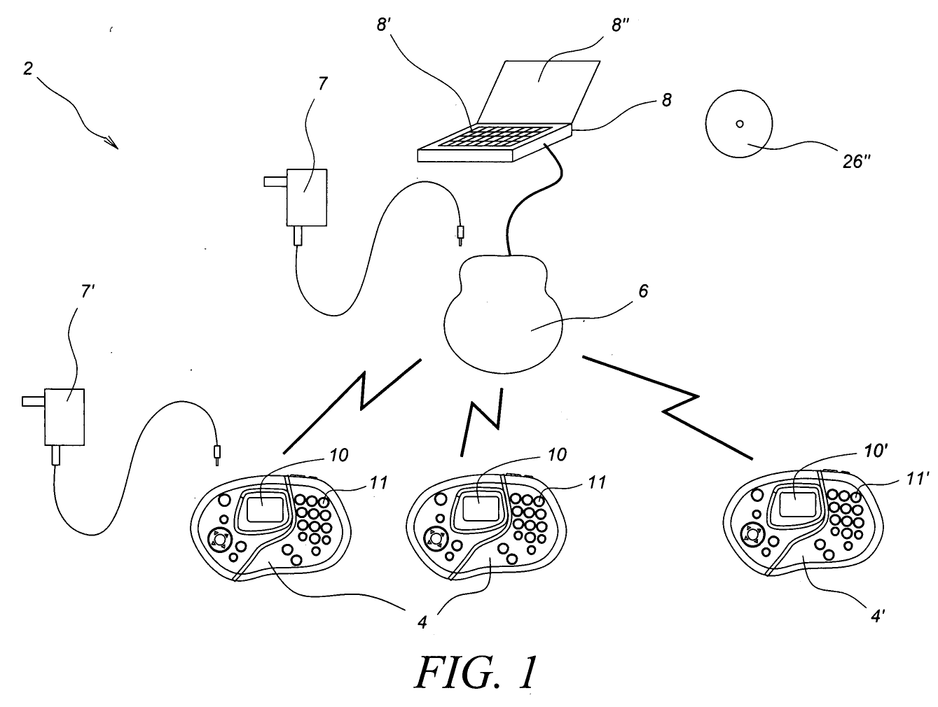

In some embodiments of the present invention an audience response system 2 is provided, having one or more audience response units 4 and a host unit 6, as can be seen in FIG. 1. The host unit 6 may be communicatively connected to a personal computer (PC) 8, including, for example, a laptop or desktop PC, normally having a keyboard 8′, mouse or pointer, monitor or display device 8″, CPU, hard drive, and a device for reading instructions or data from a computer readable medium (the PC 8 is illustrated generally without specifically illustrating some internal and external components that are common and widely implemented in enabling the function of PC's). A wireless communication link is provided between the audience response units 4 and the host unit 6 by one or more radio frequency (RF) modules. In some embodiments, the RF modules are compliant with the 802.15.4 standard developed by the Institute of Electrical and Electronics Engineers (hereinafter “IEEE 802.15.4”).

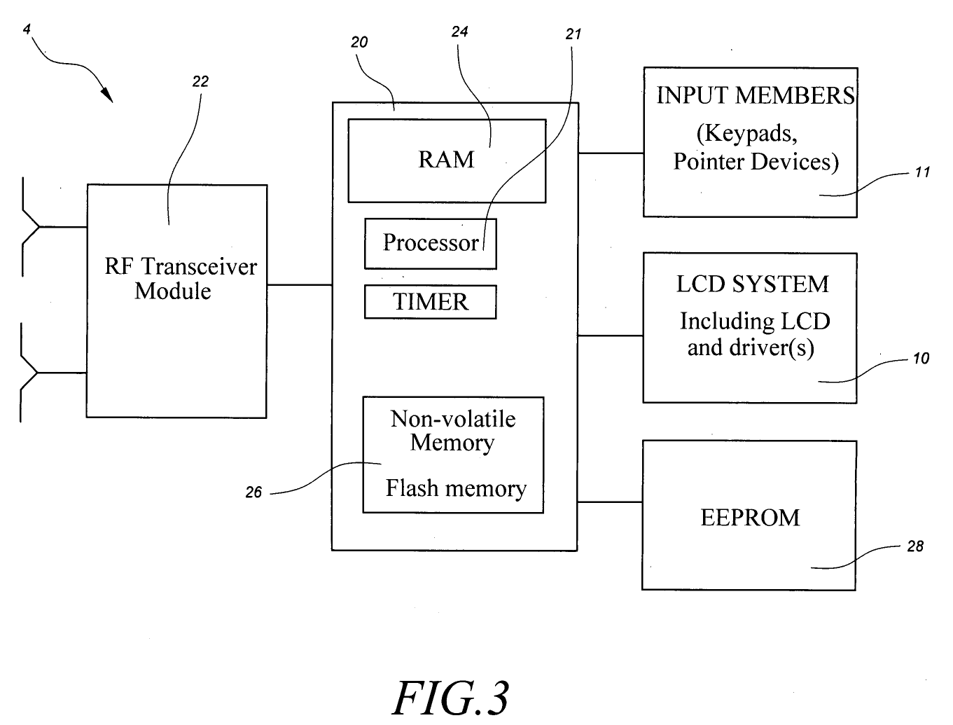

Various embodiments of the audience response units 4 (also referred to herein as “portable units” or “remotes”) can be provided including that illustrated as a simplified block diagram in FIG. 3, which comprises a display, such as an LCD 10 (liquid crystal display), input members 11 (e.g. manually operable input members such as, without limitation, keys, buttons, switches and pointers), an RF transceiver unit or module 22 and a microcontroller 20 having a processor 21, along with integral or peripheral RAM 24, writable non-volatile memory 26, such as flash memory, and EEPROM 28.

The RF transceiver 22 can be a low power and short range transceiver, such as, without limitation, the MC13191 or MC13192 transceivers by FREESCALE SEMICONDUCTOR, with each transceiver being coupled to a master device (e.g., processing module or microcontroller) within each respective unit 4, 6. The RF transceiver 22 and design of the microcontroller 20 for each unit is selectable based on application requirements in audience response system 2; however, some embodiments of the present invention utilize the MC13192 coupled to an 8-bit microcontroller (MCU). Suitable 8-bit microcontrollers can include the FREESCALE SEMICONDUCTOR MC9S08GT and MC9S08 GB series. Various other widely available substitute processors/controllers and RF transceiver modules can be employed in the present invention to meet processing requirements depending on the application.

As will be appreciated by one skilled in the art, the described wireless communication link can be specified and configured to support various networking topologies, depending on the particular application. In a first embodiment, the audience response system 2 is configured in a “star topology” with a network coordinator, or host unit 6. The host unit 6 may be a full function device or connected to a full function device, with the host unit 6 having an RF module coupled to a microcontroller or processor, and with the RF module and controller comprising same or similar hardware components as the audience response units 4. In addition, the host unit 6 can be coupled to a personal computer 8, which can be used for processing input data entered via the audience response units 4 by audience members and for executing specific applications software or other programs for use within the audience response system 2 to define and operate an application environment of the audience response system 2.

The transmissions processes within the disclosed audience response system 2 can comprise a beacon mode with contention access periods and, in some embodiments, collision free periods within guaranteed time slots. Alternative embodiments can be implemented in a non-beacon mode. The audience response units 4 can “check-in” to transmit signal packets or to receive signal packets from the host unit 6 using a procedure involving carrier sense multiple access with collisions avoidance (CSMA-CA), as will be appreciated by those skilled in the art after reviewing this disclosure. In other embodiments, transmissions can employ other variations of clear channel assessment processes, with or without a randomized back-off, and with the randomized back-off occurring before a clear channel assessment or after.

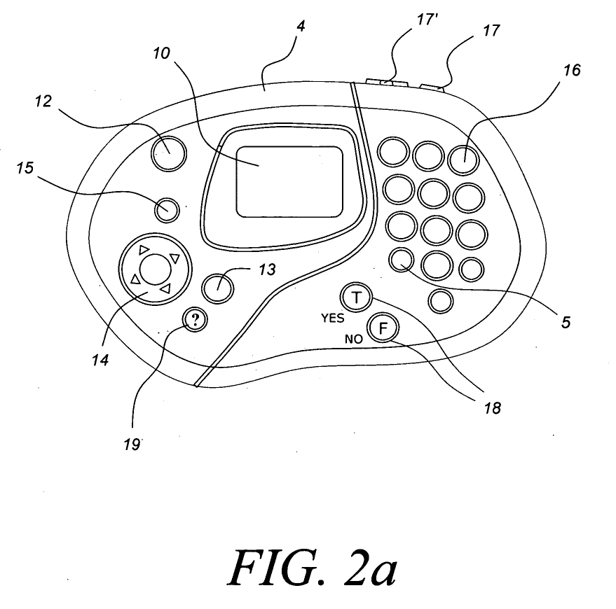

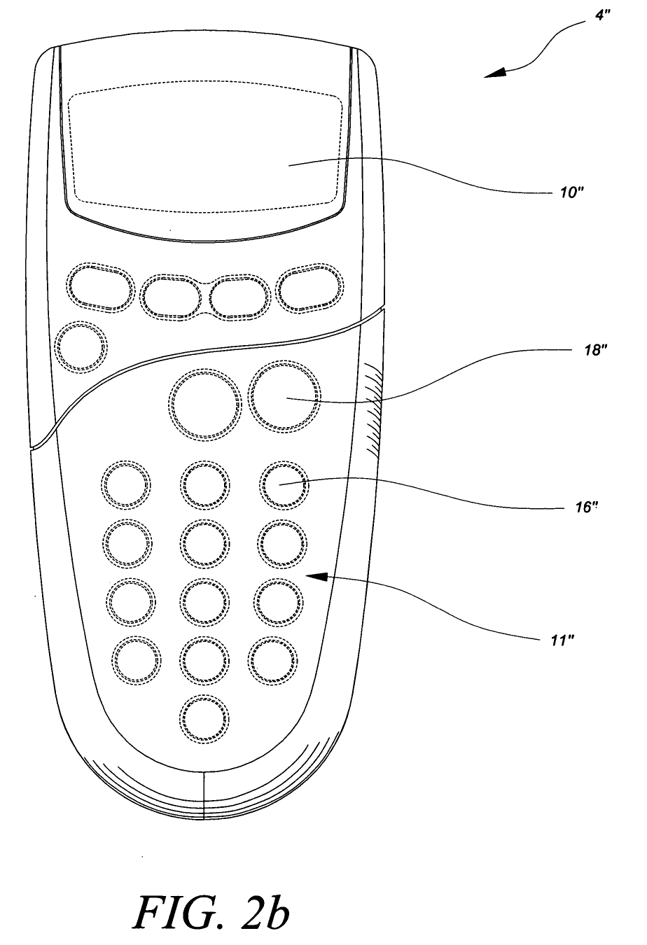

Referring to FIG. 2a, an embodiment of the audience response unit 4 is illustrated having various manually operable input members 11 which can include input members 12, 13, 14, 15, 16, 17, 17′, 18 and 19, including a multidirectional cursor key 14, in the embodiment illustrated in FIG. 2a, and an alphanumeric keypad 16. Some input members 11 can be configured as designated keys 18 that are signified by permanent markings on the keys or a surface of the portable module 4, such as, for example, “YES” or “NO” markings along with “T” or “F” 18 (signifying “TRUE” or “FALSE” in some embodiments) to simplify action required by a user to input responses to certain inquiries posed within the audience response system 2. An alternative embodiment for an audience response unit 4″ of the present invention is also illustrated in FIG. 2b, which can have reduced keypad space but with substantially similar functional components to those illustrated in the block diagram of FIG. 3 for the embodiment in FIG. 2a.

In the embodiment of FIG. 2a, the multidirectional cursor key 14 can be used to control a cursor illustrated on a graphical user interface (GUI) (not drawn) on the display device 10 of the audience response unit 4, in order to provide input to the microcontroller 20. In some embodiments the multidirectional cursor can be used to scroll through GUI menu systems, or select input parameters, all of which are displayable by a display device 10 (e.g., LCD) of the audience response unit 4. Alternatively, or in conjunction with the multidirectional cursor key 14, the alphanumeric keypad 16 and other input members 11 can also be used to provide user input to the microcontroller 20.

As will be appreciated by those skilled in the art, in some embodiments, one or more applications or programs executed by the PC 8 to define an application environment of the audience response system 2 can also be configured to allowing users to preprogram activities, such as those involving questions or inquiries to be posed to audience members. Inquiries can be displayed on the LCD 10 of the audience response units 4 via communication through the host unit 6 and in other embodiments, the inquiries are displayed on a commonly viewable display device visible to all audience members, such as a display screen of the PC 8 or a collateral display device, such as a projection device (not illustrated) coupled to the PC 8. In other embodiments, combinations of different display devices are used.

The host unit 6 can transmit information or instruction to the audience response units 4. For example, graphical user interfaces (GUIs) displayable on the LCDs 10′ of the audience response units 4 can be coordinated or operated through signals received from the host unit 4 in combination with input received from individual audience members holding audience response units 4.

Further embodiments of the present invention also comprise methods and systems for implementing check-in periods for audience response units 4, with the check-in periods being dependent on the quantity or number of audience response units 4 on the network or channel. Checking-in can include, without limitation, transmitting messages, data or instruction or otherwise packets of information from the audience response unit 4 to the host unit 6, such as, for example, question answers, and can include executing an access algorithm (e.g., determining if the channel is clear and implementing a random back-off mechanism), such as those previously discussed. Checking-in can also include instructing the host unit 6 to respond to the audience response unit 4 checking-in, with any private message, data or command, waiting to be sent to the audience response unit 4, whereas general messages, information or data transmitted to all response units can be provided through a beacon common to all audience response units 4.

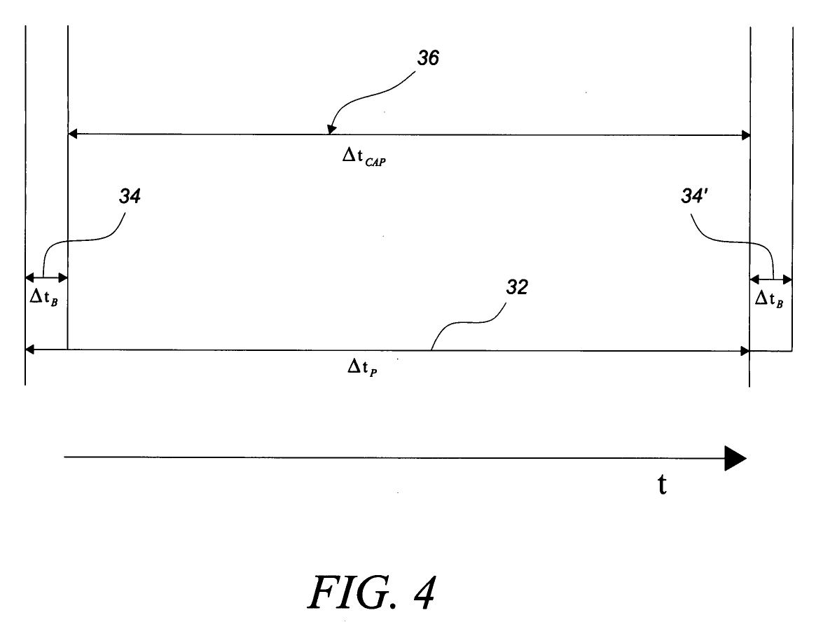

As an example, the illustration in FIG. 4 depicts a time chart showing a beacon period 32 (or Δ t_{P}) having a beacon window 34 (or Δ t_{B}) and a contention access period 36 (or Δ t_{CAP}). FIG. 4 also depicts the next beacon window 34′ of a next beacon period, wherein the beacon periods continue to cycle repetitively. During the contention access period 36, transmissions between audience response units 4 and the host unit 6 can occur using a CSMA-CA algorithm, such as that associated with the IEEE 802.15.4 standard. In other embodiments, transmissions can employ other variations of either a clear channel assessment or randomized back-off algorithm or both, as will be appreciated by those skilled in the art after reviewing this disclosure. The embodiment of the present invention shown in FIG. 4 does not include a collision free period or guaranteed timeslot for transmission.

In the example, a beacon period 32 may be approximately 250 ms (milliseconds) long, with a beacon window 34 of approximately 20 ms. During the beacon window 34, various types of information can be transmitted from the host unit 6 to the audience response units 4, such as, without limitation, a synchronization signal and a global message (e.g., question signals going from the host unit 6 to the audience response units 4). Audience response units 4 can then transmit during the contention access period 36, which is approximately 230 ms in the example provided. In various embodiments of the present invention, each of the periods and windows of time can be longer or shorter than those specifically disclosed above, as will be appreciated by those skilled in the art.

In some embodiments of the present invention, it is desired to influence a maximum quantity of audience response units 4 that check-in to the host unit 6 during a contention access period 36. In an example embodiment of the present invention, audience response units 4 can require approximately 3 ms (milliseconds) to check-in. In various embodiments of the present invention, an access algorithm may be executed and if check-in is not accomplished, the remote can wait-out an applicable check-in period before initiating the access algorithm again to attempt to check-in.

In some embodiments of the present invention, influencing the maximum number of audience response units 4 that check-in comprises adjusting the check-in period. Selecting an optimum check-in period can involve first selecting a network activity goal, such as a target number of audience response units 4 to check-in during any given contention access period 36, or otherwise over an entire beacon period 32. Without being bound by theory, the inventors hereof have determined that influencing the quantity of audience response units 4 that check-in by varying a time between check-in attempts by the audience response units (check-in period) as a function of activity type, stage, quantity of audience response units 4 logged into the network or recent check-in frequency of audience response units 4, can be beneficial to the network. Thus, in some embodiments of the present invention, the host unit 6 sends adjustments to current check-in periods as appended instruction to beacons during a beacon window 34, which are received by audience response units 4 on the network (or on a particular channel on the network).

In a first set of embodiments of the present invention, there can be fixed check-in periods, or time between check-ins, that are set as a function of the quantity of audience response units 4 logged into a network. In such embodiments, as the number of audience response units 4 goes up, the check-in period can be lengthened and the host unit 6 can transmit the desired check-in period to the audience response units 4 during the beacon window 34. As an example of fixed check-in periods, the following TABLE 1 shows selectable fixed check-in periods for some embodiments of the present invention, wherein a fixed check-in period can be selected as a function of the number of audience response units 4 on the network. This TABLE 1 can be used in example embodiments of the present invention when a beacon window 34 is approximately 20 ms (milliseconds); the beacon period 32 is approximately 250 ms; and the audience response units 4 can require about (or about an average of) 3 ms to check-in.

TABLE 1
Example of Fixed Check-in Periods
Dependent On Number of Audience Response Units
In a Network (e.g. a classroom size)

| Number of Audience | |
|---|---|
| Response Units | Check-in period |
| below 32 | 0.5 sec |
| 32-63 | 1.0 sec |
| 64-127 | 2.0 sec |
| 128-255 | 4.0 sec |
| 256-511 | 8.0 sec |
| more than 511 | 16.0 sec |

In further embodiments of the present invention, the current check-in period can be adjusted as a function of one or more factors or variables as now described. Various ones of these factors and variables are now described, and then examples of their use in adjusting check-in periods are provided.

An example factor is an activity type, such as, for example, the start of a question being posed to audience members. After the presentation of a question to an audience, activity on the network can be heavier, as a large portion of the audience population is expected to respond, and then traffic may decrease over time as audience members have responded, depending on the response time profile. In order for such activity type to be factored into adjusting check-in periods for the audience response units 4, the activity is automatically indicated to the host unit 6, such as when questions are posed through a software application on a computer and the computer is connected to the host unit 6 and capable of notifying the host unit 6 that a question has been presented.

Also, another factor that can be considered in adjusting check-in periods is a “maximum” check-in period, with the term the “maximum” referring to a circumstance in which all audience response units 4 on a network are attempting to check-in simultaneously. An acceptable maximum check-in period can be predetermined and set in order to ensure that the network activity will not exceed a certain portion of the network's “theoretical capacity.” For illustrative purposes, an example is now described for some embodiments of the present invention, wherein there is a contention access period Δ t_{CAP} of about 230 ms and a time for check-in for each remote of about 3 ms. In such embodiments, a “theoretical capacity” would be 76.7 audience response units 4 checking in during each contention access period (i.e., 230 ms divided by 3 ms=76.7). The maximum check-in period can be set to achieve a portion of the “theoretical capacity” in network activity, such as, for example, 25% of the theoretical capacity, or about 19 units (i.e., 25% of 76.7). In other embodiments of the present invention, the maximum check-in period is set to achieve more or less than 25% of the theoretical capacity or between 15% and 55% of the theoretical capacity.

Also, in some embodiments of the present invention, a minimum check-in period can be set as a function of the maximum check-in period. For example, it can be set as one eighth (⅛^{th}) of the maximum check-in period. Also, the minimum check-in period can be more or less than ⅛^{th} of the maximum check-in period if desired, as will be appreciated by those skilled in the art after reviewing this disclosure.

In yet further embodiments of the present invention, the check-in periods are also adjusted as a function of recent check-in frequency of audience response units 4. The check-in frequency can be measured as the number of audience response units 4 that check-in over the most recent four (4) beacon periods or cycles. In other embodiments, the check-in frequency of the remotes can be measured over a larger number or smaller number of beacon periods.

Now referring to some embodiments of the present invention utilizing various factors or variables such as those described, supra, to adjust check-in periods: In an example embodiment of the present invention having a beacon window 34 of approximately 20 ms; a beacon period 32 of approximately 250 ms and a time for check-in of about 3 ms for each remote, the check-in period can be adjusted at the start of a presentation of a question in accord with TABLE 2, shown below.

TABLE 2
As a Function of Activity and Number of Audience Response Units

| Column 1 | | | |
|---|---|---|---|
| Number of | Column 2 | Column 3 | Column 4 |
| Audience | Maximum | Question Start | Minimum |
| Response | Check-in | Check-in | Check-in |
| Units | Period | Period | Period |
| <32 | 0.5 sec | 0.25 sec | 0.25 sec |
| 32-63 | 1.0 sec | 0.25 sec | 0.25 sec |
| 64-127 | 2.0 sec | 0.5 sec | 0.25 sec |
| 128-255 | 4.0 sec | 1.0 sec | 0.5 sec |
| 256-511 | 8.0 sec | 2.0 sec | 1.0 sec |
| >511 | 16.0 sec | 4.0 sec | 2.0 sec |

For example, if 50 (fifty) audience response units, as shown in the second row of TABLE 2 under Column 1, are logged into a network when a question start is presented, the host unit 6 can immediately instruct the audience response units 4 to implement a check-in period of 0.25 seconds, as shown under Column 3. This is an example of utilizing activity type to adjust a check-in period. As will be appreciated by those skilled in the art after reviewing this disclosure, various other activity types may be used to adjust check-in periods.

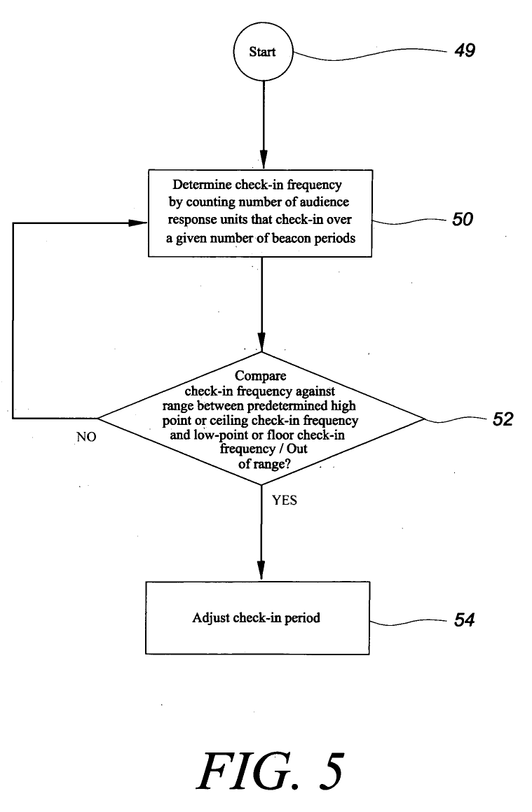

In some embodiments of the present invention, after the check-in period is set according to TABLE 2, the frequency with which audience response units 4 check-in is monitored at the host unit 6, as shown in step 50 of FIG. 5. At step 52, the check-in frequency is then compared with various ranges of frequencies. If the check-in frequency is at or above a ceiling value or ceiling range (e.g., at or above 25% of the theoretical capacity, which can be measured as about seventy-five (75) units checking-in for every four beacon periods or about eighteen (18) units checking-in for every one beacon period), then the check-in period is adjusted upward, such as, for example, by increasing it by a factor of two, to reduce network activity. See step 54, FIG. 5. If the number of audience response units that check-in over a given number of beacon periods is at a floor value or floor range, (e.g. fewer than forty-five (45) units over four beacon periods, or fewer than ten (10) units over one beacon period), then the current check-in period is adjusted downward, such as, for example, by one half (i.e., divided by two). If the check-in frequency is in a middle or acceptable range (e.g., between forty-five (45) to seventy-five (75) over four beacon periods or between ten (10) and eighteen (18) over one beacon period), then no adjustment is made based on check-in frequency. In some embodiments of the present invention, the check-in frequency is determined every four beacon periods, while in others, it is determined over longer or shorter intervals of time, such as one beacon period. Also, as those skilled in the art will appreciate after reviewing the present disclosure, the ceiling, floor, and middle range check-in frequencies upon which adjustments are based can be higher, lower or wider in range and the adjustments themselves can be larger or smaller adjustments.

Furthermore, in some embodiments of the present invention, the check-in periods are constrained between the maximum check-in period, as shown in Column 2 of TABLE 2, and the minimum check-in period, as shown in Column 4 of TABLE 2. Thus, although the check-in periods may be adjustable as a function of check-in frequency of the audience response units, they may be constrained by an upper limit with the maximum check-in period and a lower limit with the minimum check-in period.

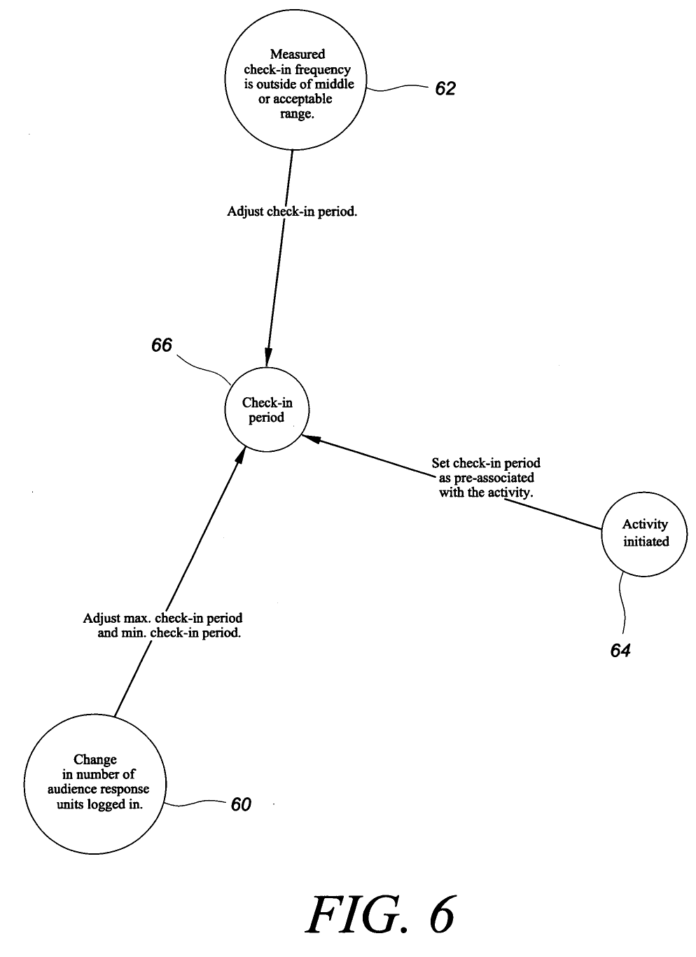

Thus, referring to FIG. 6, check-in periods can be a function of changes in the number of audience response units 4 logged into the network, as shown in event 60; changes in measured check-in frequency, as shown in event 62; and initiation of an activity, such as posing a question, as shown in event 64. As those skilled in the art will appreciate after reviewing the present disclosure, the priority level of events 60, 62, and 64 in their impact on check-in periods can be programmed in various manners to achieve different variations of the prevent invention.

Although specific embodiments and examples of the invention have been described supra for illustrative purposes, various equivalent modifications can be made without departing from the spirit and scope of the invention, as will be recognized by those skilled in the relevant art after reviewing the present disclosure. The various embodiments described can be combined to provide further embodiments. The described devices and methods can omit some elements or acts, can add other elements or acts, or can combine the elements or execute the acts in a different order than that illustrated, to achieve various advantages of the invention. These and other changes can be made to the invention in light of the above detailed description.

In general, in the following claims, the terms used should not be construed to limit the invention to the specific embodiments disclosed in the specification. Accordingly, the invention is not limited by the disclosure, but instead its scope is determined entirely by the following claims.

What is claimed is:

1. An audience response system comprising:
at least one host unit; and
a plurality of audience response units, said host unit and plurality of audience response units being configured to communicate in a wireless setting in which the host unit transmits at least one check-in period to the plurality of audience response units and wherein the audience response units check-in as a function of the at least one check-in period.

2. The audience response system of claim 1 wherein the wireless setting is a network setting and the at least one check-in period is determined as a function of a number of audience response units logged into a network.

3. The audience response system of claim 1 wherein the wireless setting is a network and wherein a plurality of check-in periods are adjustably determined but constrained by upper and lower limits, with the upper and lower limits being a function of the number of audience response units logged into the network.

4. The audience response system of claim 1 wherein the at least one check-in period is determined as a function of an activity conducted on the network.

5. The audience response system of claim 4 wherein the activity is the start of a question presented to an audience for response using the audience response units.

6. The audience response system of claim 4 wherein when an activity occurs, the at least one check-in period is set to a value pre-associated with the activity.

7. The audience response system of claim 1 wherein the at least one check-in period is determined as a function of a measured frequency with which audience response units are checking-in to the host unit.

8. The audience response system of claim 7 wherein the measured frequency is measured by counting the number of audience response units that have checked-in over at least one beacon period.

9. The audience response system of claim 8 further comprising adjusting at least one check-in period upward when the measured frequency is determined to be at or above a first predetermined value or adjusting at least one check-in period downward when the measured frequency is determined to be at or below a second predetermined value.

10. The audience response system of claim 9 wherein the predetermined values are between about fifteen to fifty-five percent of a maximum theoretical capacity of the audience response system.

11. The audience response system of claim 9 wherein the first predetermined value is about twenty-five percent of a maximum theoretical capacity of the audience response system.

12. The audience response system of claim 7 wherein the determined check-in period is constrained by an upper limit and a lower limit.

13. The audience response system of claim 12 wherein the upper limit and lower limit are a function of the number of audience response units logged into a network.

14. The audience response system of claim 1 wherein the audience response units are also configured to execute a random back-off delay prior to transmitting information.

15. The audience response system of claim 14 wherein the audience response units are configured to assess the state of a channel prior to transmitting information.

16. A method of communicating using an audience response system having a host unit and a plurality of audience response units that are communicatively connected within a wireless network, comprising:
adjusting check-in periods of the audience response units, the check-in periods being a function of check-in frequency on the network; and
transmitting the adjusted check-in periods to a plurality of the audience response units.

17. The method of claim 16 further comprising adjusting the check-in periods as a function of an activity conducted on the network.

18. The method of claim 16 further comprising adjusting the check-in periods as a function of the start of a question posed to audience members.

19. The method of claim 16 further comprising adjusting the check-in periods as a function of a number of audience response units active on the network.

20. The method of claim 16 further comprising providing a maximum and minimum constraint on the check-in periods as a function of the number of audience response units active on the network.

21. A method of communicating using an audience response system having a host unit and a plurality of audience response units that are communicatively connected within a wireless network, comprising:
initiating a check-in by an audience response unit to transmit a message from the audience response unit to the host unit; and
initiating a check-in by the audience response unit to retrieve information from the host unit, wherein when the audience response unit is successful in checking-in to the host unit, the host unit transmits information to the audience response unit.

22. The method of claim 21 further comprising adjusting periods of the audience response unit as a function of a frequency with which the audience response units are checking-in at the host unit.

23. The method of claim 21 wherein any transmission sent to an individual audience response unit from the host unit is initiated by the individual audience response unit checking-in.
